(19) United States
(12) Patent Application Publication
(10) Pub. No.: US 2011/0125462 A1
(43) Pub. Date: May 26, 2011

(54) TETHERLESS TUBE INSPECTION SYSTEM

(75) Inventors: Lyman J. Petrosky, Latrobe, PA (US); Jayne L. Boynton, New Stanton, PA (US); Keith B. Lloyd, Ruffsdale, PA (US)

(73) Assignee: Westinghouse Electric Company LLC, Monroeville, PA (US)

(21) Appl. No.: 12/779,967

(22) Filed: May 14, 2010

Related U.S. Application Data
(60) Provisional application No. 61/178,190, filed on May 14, 2009.

(51) Int. Cl. G06F 15/00; G01D 21/00

(52) U.S. Cl. 702/188; 73/865.8; 702/127; 901/46

(57) ABSTRACT

Apparatus and a method to inspect tubing by means of a free flying, autonomous inspection head that is not attached by wires to external control and data acquisition equipment. The inspection head travels through the tube with an attached module that integrates all the necessary support for the electronic and mechanical control of a nondestructive sensor within the inspection head.

### CROSS REFERENCE TO RELATED APPLICATION

This application claims the priority of Provisional Application Ser. No. 61/178,190, filed May 14, 2009.

### BACKGROUND OF THE INVENTION

1. Field of the Invention

The present invention relates generally to nondestructive examination of heat exchanger tubing and more particularly to a tetherless self-contained inspection system that can traverse small tubing diameters.

2. Related Art

Steam generators used in nuclear power plants are very large heat exchangers where heat from a primary fluid heated by a nuclear reactor is transferred to a secondary fluid which is converted into steam and used to drive a turbine generator. Steam generators are housed inside a tall, generally cylindrical steel shell. A large number of U-shaped heat exchanger tubes are enclosed in the shell and have their ends inserted in holes formed in a horizontal tube sheet or plate near the bottom of the steel shell. The tubes are used to convey the primary fluid which has been heated in the nuclear reactor. The secondary fluid or feedwater used to generate the steam is introduced into the steam generator in such a manner that the secondary fluid flows around the outside of the heated tubes thereby converting much of the secondary fluid into steam which is allowed to exit the steam generator through an outlet nozzle at the top of the steel shell.

In the past, steam generator tubing in nuclear plants have been exposed to extreme operating conditions and were susceptible to stress corrosion cracking, mechanical wear, wall thinning and pitting. To address this susceptibility, a number of techniques have been developed to inspect steam generator tubing for degradation prior to tubing failure in order to prevent leakage of the primary radioactive coolant into the secondary side which would result in forced outages. Steam generator tubing has been most commonly inspected using a plurality of eddy current methods, most involving probes which were inserted into the tubes from the underside of the tube sheet on the primary side of the steam generator. The probes are inserted through a steam generator manway in the lower hemispherical inlet and outlet side of the steam generator, below the tube sheet and into the tube sheet, whereby the corresponding tubes are mapped by inserting the probes up through the tubes.

One type of eddy current probe that is used for this purpose is the “Bobbin”-type, wherein two coils of copper wire are wound circumferentially around a relatively rigid core to create the test coil. Although widely and relatively successfully used, the relatively rigid Bobbin-type probes are difficult to push through tubes that have bends.

Another type of eddy current probe is a rotating pancake coil probe. The rotating pancake coil probe is ordinarily mounted on a motorized sheath which allows the coil to be simultaneously rotated and translated through the tube thereby developing a helical scan of the tube surface. The pancake eddy current coil axis is normal to the tube inside diameter surface and generally the coil is mounted in an articulating mechanism that allows the coil to follow the inside diameter surface contour, and to maintain a relatively constant coil liftoff.

A third type of eddy current probe employs as many as forty individual coils that are arranged circumferentially around the probe. Each of the coils provide its own individual output of the opposing inside surface of the heat exchanger tube as the probe is translated axially through the tube.

Generally, each of the foregoing probes needs to be centered as they move through the interior of the heat exchanger tubes. Typically, the probes are centered employing compliant pads that extend out radially at spaced circumferential locations around the probe at generally two spaced axial positions. Though highly accurate, the eddy current method of inspecting steam generator tubing is relative slow and preferably the probes, which are typically pushed along the length of tubing by a flexible shaft, should be inserted at a constant rate. Side loads developed by the pushing shaft as the probe traverses bends in the tubing and to a lesser extent side loads due to off center shaft positioning in the straight lengths can adversely impact the centering of the probe or its forward progress. Further improved means for centering the probes are described in co-pending application Ser. No. 12/582,196, filed Oct. 20, 2009 and assigned to the assignee of this invention.

Furthermore, existing inspection equipment is bulky and the long flexible shaft that is used to push the inspection probe through the length of the tubes becomes highly contaminated. Additionally, the shaft is subject to buckling, which causes difficulties during the inspection operation.

Accordingly, it is an object of this invention to eliminate the use of a flexible shaft to push the inspection probe through the tube.

Furthermore, it is an object of this invention to provide an improved means for driving the sensor through the tube that will speed up the inspection time and reduce drag on the sensors that are currently caused by the power and communication cables that energize the sensor and communicate its output to a data gathering station.

### SUMMARY OF THE INVENTION

These and other objects are achieved by the nondestructive inspection probe system of this invention which basically includes a nondestructive inspection sensor sized to movably fit within the tubing to be inspected, with the inspection sensor having one of either a male or female disconnectable coupling. The nondestructive inspection probe system of this invention further includes an electronics module sized to movably fit within the tubing with the electronics module having the other of either the male or female disconnectable coupling which is adapted to connect to the one of either the male or female disconnectable coupling on the inspection sensor and when so connected to electrically communicate with the nondestructive inspection sensor. The electronics module is so configured to move within the tubing along with the nondestructive sensor, while receiving data from the sensor without any tethering extending outside the interior of the tubing. The electronics module preferably includes a memory for storing the data from the nondestructive inspection sensor and desirably, the data is communicated from the electronics module memory to a data collection center at the end of the inspection of each tube. Desirably, the electronics module includes a control for adjusting the speed of movement of the nondestructive inspection sensor within the tubing. In one embodiment, the control for adjusting the speed controls a drag of the nondestructive inspection sensor on the interior of the tubing.

In still another embodiment, the electronics module includes a data communication protocol for communicating the data from the nondestructive inspection sensor to a remote data collection center. Desirably, the data communications protocol is a wireless data transmission method and preferably the data is communicated intermittently.

The nondestructive inspection probe system of this invention further includes a drive system for moving the nondestructive inspection sensor through the tubing. The tubing has a first and second end and in one embodiment the drive system creates a pressure differential between the first and second end that drives the nondestructive inspection sensor. Preferably, the pressure differential is created by injecting a compressed gas, for example air, into the tubing. In another embodiment, the drive system comprises wheels that are driven by an electric drive motor and preferably, the drive wheels and the electric drive motor are on the electronics module.

Furthermore, the electronics modules of this invention includes an electric source that powers the nondestructive inspection sensor and provides an excitation signal to the nondestructive inspection sensor. In the latter case, the electronics module controls the excitation frequency and timing of the excitation signal. Preferably, the electronics module provides an additional reference signal equivalent to a response of the nondestructive inspection sensor in clean tubing and preferably, the electronics module measures the impedance of the nondestructive inspection sensor to the excitation signal. Preferably, the electronics module correlates the data to the nondestructive inspection sensor's position relative to the interior of the tubing. In the latter case, the electronics module communicates with a remote data center the position of the nondestructive inspection sensor and provides a fault notification.

In yet another embodiment, wherein the tubing has a unique identifier, the electronics module has a monitor that reads the unique identifier and stores the unique identifier with the data. In one embodiment, the unique identifier is a radio frequency identification tag (RFID tag) and the electronics module has a monitor that reads the RFID tag.

This invention further contemplates a method of inspecting tubing having a first and second end with an inspection probe connected to an electronics module, with both the inspection probe and the electronics module sized to movably fit within the tubing without any tethering extending outside the tubing. The method includes the steps of employing a first robot to introduce the inspection probe, connected to the electronics module, into the first end of the tubing. The method then blows or sucks the inspection probe connected to the electronics module through the tubing from the first end to the second end of the tubing. The probe inspects the tubing as it moves from the first to the second end. A second robot is then employed to remove the probe connected to the electronics module from the second end of the tubing. In another embodiment, where the tubing comprises a plurality of tubes supported in parallel in a tube bundle, the method desirably includes the step of sequentially employing the first robot to introduce a first inspection probe into a first tube and a second inspection probe into a second tube and simultaneously blows or sucks the first inspection probe through the first tube and the second inspection probe through the second tube so that the second robot can sequentially remove the first inspection probe from the first tube and the second inspection probe from the second tube. In another embodiment, wherein the tubing includes a first and a second tube supported in parallel in a tube bundle, the method contemplates the steps of using a second robot to introduce the first inspection probe connected to the electronics module into a second end of the second tube and blowing or sucking the inspection probe connected to the electronics module through the second tube from the second end to a first end of the second tube. The first robot is them employed to remove the inspection probe connected to the electronics module from the first end of the second tube.

### BRIEF DESCRIPTION OF THE DRAWINGS

A further understanding of the invention can be gained from the following description of the preferred embodiments when read in conjunction with the accompanying drawings in which:

FIG. 1 is a perspective view, partially cut away, of a vertical steam generator for which the nondestructive inspection probe system of this invention can be applied;

FIG. 2 is a plan view, partially in section, of the nondestructive inspection probe system of this invention inside a steam generator tube to be inspected; and

FIG. 3 is a side view partially in section of a robotic system which can be used for inserting and withdrawing the nondestructive inspection probe system of this invention into and from steam generator tubes.

### DESCRIPTION OF THE PREFERRED EMBODIMENTS

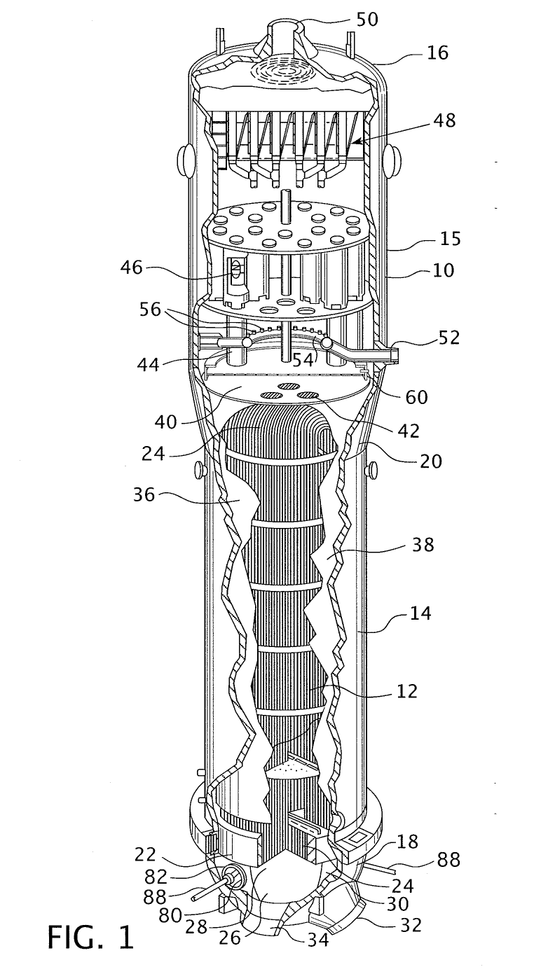

Referring to the drawings, FIG. 1 shows a steam or vapor generator 10 that utilizes a plurality of U-shaped tubes which form a tube bundle 12 to provide the heating surface required to transfer heat from a primary fluid traveling within the tubes to vaporize or boil a secondary fluid surrounding the outside of the tubes. The steam generator 10 comprises a vessel having a vertically oriented tubular shell having a lower reduced diameter portion 14, a conical center portion 20 and an enlarged diameter upper portion 15 that is capped by a top enclosure or dished head 16 enclosing the upper end and a generally hemispherical shaped channel head 18 enclosing the lower end. A tube sheet 22 is attached to the channel head 18 and has a plurality of holes disposed therein to receive the ends of the U-shaped tubes. A dividing plate 26 is centrally disposed within the channel head 18 to divide the channel head into two compartments 28 and 30, which serve as headers for the tube bundle 12. Compartment 30 is the primary fluid inlet compartment and has a primary fluid inlet nozzle 32 in fluid communication therewith. Compartment 28 is the primary fluid outlet compartment and has a primary fluid outlet nozzle 34 in fluid communication therewith. Thus, primary fluid, i.e., the reactor coolant, which enters fluid compartment 30 is caused to flow through the tube bundle 12 and out through outlet nozzle 34.

The tube bundle 12 is encircled by a wrapper 36 which forms an annular passage 38 between the wrapper 36 and the lower shell and conical portions 14 and 20, respectively. The top of the wrapper 36 is covered by a lower deck plate 40 which includes a plurality of openings 42 in fluid communication with a plurality of riser tubes 44. Swirl vanes 46 are disposed within the riser tubes to cause steam flowing therethrough to spin and centrifugally remove some of the moisture entrained within the steam as it flows through the primary centrifugal separator. The water separated from the steam in this primary separator is returned to the top surface of the lower deck plate. After flowing through the primary centrifugal separator, the steam passes through a secondary separator 48 before reaching a steam outlet 50 centrally disposed in the dished head 16.

The feedwater inlet structure of this generator includes a feedwater inlet nozzle 52 having a generally horizontal portion called a feedring 54 and discharge nozzles 56 elevated above the feedring. The feedwater supplied through the feedwater inlet nozzle 52 passes through the feedring 54 and exits through discharge nozzle 56 and mixes with water which was separated from the steam and is being recirculated. The mixture then flows down above the lower deck plate 40 into the annular passage 38. The water then enters the tube bundle at the lower portion of the wrapper 36 and flows along and up the tube bundle where it is heated to generate steam.

The steam generator described above is what is known as a “U-bend” design, because every tube has a single “U” bend 24 midway along its length. A number of other design variations are commonly encountered, such as “square bend” in which the “U” is replaced by two small radius bends (typically nine inches) and a straight section. There are also steam generators with entirely straight tubes, which feature a plenum at each end of the tube bundle. Regardless of the specific, tube pattern and bend arrangement, the invention described herein is applicable to the inspection of the tubes.

During operation of the steam generator sludge settles around the tubes and loose parts that traverse the tube bundle create an extreme operating environment that makes the tubes in the tube bundle susceptible to stress corrosion cracking, mechanical wear, wall thinning and pitting. To address this susceptibility, a number of techniques have been developed to inspect steam generator tubing for degradation prior to tubing failure in order to prevent forced outages. Steam generator tubing has been most commonly inspected using a variety of eddy current methods, most involving probes which are inserted into the tubes from the underside of the tube sheet 22 on the primary side of the steam generator. The probes are inserted through a steam generator manway in the lower hemispherical inlet and outlet sides of the generator below the tube sheet 22 and into the tube sheet where the corresponding tubes are mapped by inserting the probes up through the tubes.

Though highly accurate, the eddy current method of inspecting steam generator tubing is relatively slow and expensive. It is an object of this invention to simplify and speed up the inspection process and further improve its accuracy.

This invention provides a system and related method to inspect tubing by means of a free flying or autonomous inspection head that is not attached by wires to control or data acquisition equipment. The inspection head travels through the tube along with an attached module that integrates all the necessary support for the electronic and mechanical control of the probe. The system is especially beneficial for use with small diameter tubing, e.g., ⅝-⅞ inch (1.59-2.22 cm) outside diameter, which imposes extreme dimensional limitations and requires a high degree of integration.

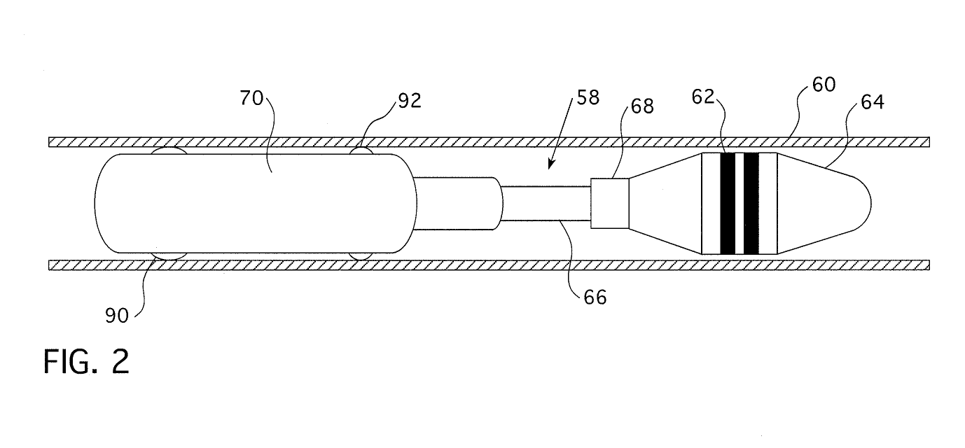

FIG. 2 shows one preferred embodiment of the nondestructive inspection probe system 58 of this invention inserted into a steam generator tube 60. The nondestructive inspection probe system 58 includes a nondestructive inspection sensor such as eddy current coil 62 that is contained in a probe head 64 that connects by way of a short flexible shaft 66 with a quick disconnect 68, to an electronics module 70 that includes all the necessary support hardware and software to energize the coils 62, control the speed of the probe head 64, collect the sensor inspection data and map the tube as the nondestructive probe inspection system 58 moves through the tubing 60. Though an eddy current probe, in this case a Bobbin probe, is illustrated as the nondestructive inspection sensor 62 it should be appreciated that the sensor can be any kind of eddy current probe, ultrasonic probe, camera or other nondestructive sensor or sampling device. The quick disconnect 68 can be any secure plug and socket connection such as a screw or bayonet coupling that will quickly and securely connect and maintain an electrical coupling between the electronics module 70 and the sensor head 64 to provide the energizing current to the sensor 62 and receive the output from the sensor.

The electronics module 70 integrates the numerous functions required to perform the inspection with the probe head 64. These functions include, but are not limited to the following:
1. provide an excitation signal, typically a complex radiofrequency signal, to the probe head 64;
2. provide programmable excitation frequencies to meet various prescribed signal configurations;
3. provide a reference signal equivalent to the probe in a clean tube;
4. measure both the resistive and reactive components of the impedance of the probe to the applied signal;
5. digitize and record the impedance information with respect to the probe's position;
6. transmit the acquired data to an external system either continuously or upon reaching the tube end;
7. control the speed of the probe as it travels along the tube; and
8. communicate with an external system for position monitoring and fault notification.
   To support the above functions, the electronics module includes a power source, such as a battery, a communication system such as WI-FI, data storage and processing electronics and a speed control system, such as that described in co-pending application Ser. No. 12/582,196, filed Oct. 20, 2009, and entitled Eddy Current Inspection Probe.

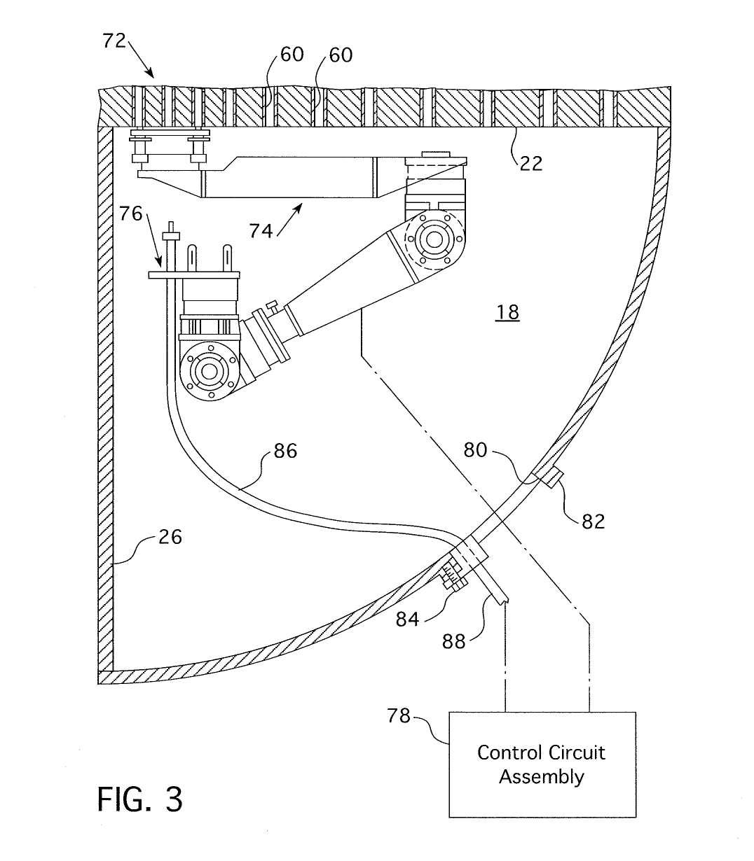

Typically, the nondestructive inspection probe system of this invention would be delivered to one end of a steam generator tube 60 by a robot, placed in the tube, and then pushed through the tube by air pressure supplied by the delivery robot. One such robotic system which can be employed for this purpose is described in more detail in U.S. Pat. No. 5,355,068, issued Oct. 11, 1994, and is shown schematically in FIG. 3. Wherein applicable, like reference numbers designate like components throughout the several figures. The robotic system 72 generally comprises a robotic arm 74 that is capable of manipulating an end effector 76 that can be employed to insert and withdraw the nondestructive inspection probe system of this invention into and from the steam generator tubes 60, under the command of a control circuit assembly 78 that simultaneously controls both the movement of the arm 74 and the operation of the end effector 76. The control circuit assembly 78 can also provide wireless command signals to the electronics module 70 shown in FIG. 2 and receive the inspection data and mapping signals that are communicated wirelessly by the nondestruction inspection probe system 58 of this invention. A manway 80 is present in the convex wall of the channel head 18 for affording access to the heat exchanger tubes 60 and the tube sheet 22 after the steam generator has been shut down and drained. However, as the channel head 18 of a steam generator that has been placed in service is radioactive, the manway 80 is used more for the admission of remotely controlled tools than by service personnel who actually enter the channel head 18. The manway 80 is circumscribed around its exterior portion by an annular flange 82 having a plurality of uniformly spaced bolt holes 84 which, under normal operating circumstances, are used to secure a manway hatch (not shown) over the channel head 18. These bolt holes 84 provide a convenient anchoring point for various components of the end effectors 76 that are manipulated within the channel head 18, as well as for the loading fixture used to install the robotic arm 74.

As stated previously, the robotic arm 74 is particularly well adapted for the manipulation of the nondestructive inspection probe system of this invention, inserting it within the steam generator tubes 60, withdrawing it from the steam generator tubes 60 and delivering compressed air through the end effector tubing 86 to drive the inspection probe system through the steam generator tubes 60, all of which is controlled from the control circuit assembly 78 through the control cabling 88.

Typically, the nondestructive inspection probe system of this invention 58 would be delivered to the steam generator tube end by the robotic arm 74, placed into the tube 60, and then pushed through the tube by air pressure supplied by the delivery robotic system 72. At the far end of the steam generator tube 60, a second robot would catch the free flying probe system of this invention on the other side of the divider plate 26, off-load data, recharge the electronics module's power supply (if necessary), move the probe to the next tube to be inspected, and launch the free flying probe back to the first robot. This cycle would be repeated as many times as necessary to perform the required inspection. At various times, the nondestructive inspection probe system 58 may be moved to a maintenance area where the probe head 64 can be replaced, e.g., if it is worn.

As previously mentioned and as shown in FIG. 2, the contact wheels 90 on the electronics module 70 can be used to add drag to the system to control the speed of the probe head 64 as taught in co-pending application Ser. No. 12/582,196, filed Oct. 20, 2009. The wheels 90 can also be used to drive the inspection probe system 58 through the tubing 60 as an alternate to employing compressed air or some other gas to establish a pressure differential between one end of the tubing and the other. Furthermore, in another alternate embodiment, robotic arms 74 are employed on each side of the divider plate 26 in the channel head 18 as discussed above, and a number of nondestruction inspection probe systems are introduced sequentially in different tubes on the same side of the channel head and retrieved sequentially by the second robot on the second side of the channel head and sequentially reinserted into other tubes to speed up the inspection process.

Furthermore, the electronics module 70 may include an encoder 92 for mapping the location of the inspection probe system. The location thus mapped is correlated to the data stored in the electronics module 70 so that the location of flaws that are detected can be identified.

In still another embodiment, each of the tubes in the steam generator has a unique identifier that is read by the electronics module 70 so the data that is mapped for an individual tube is correlated to that tube. The unique identifier may be a specific marking or a radio frequency identification tag or any other unique means of identifying the tube that corresponds to the data retrieved from traversing a corresponding path of the nondestructive inspection probe system of this invention.

While specific embodiments of the invention have been described in detail, it will be appreciated by those skilled in the art that various modifications and alternatives to those details could be developed in light of the overall teachings of the disclosure. For example, instead of using a pressurized gas to establish the differential pressure that pushes the nondestructive inspection probe system of this invention through the tube, a vacuum could be applied to the downstream end of tube to accomplish the same purpose. Accordingly, the particular embodiments disclosed are meant to be illustrative only and not limiting as to the scope of the invention, which is to be given the full breadth of the appended claims and any and all equivalents thereof.

What is claimed is:

1. A nondestructive inspection probe system for inspecting an interior of an extended length of tubing comprising:
a nondestructive inspection sensor sized to moveably fit within the tubing, the inspection sensor having one of either a male or female disconnectable coupling; and
an electronics module sized to moveably fit within the tubing having another of either the male or female disconnectable coupling which is adapted to connect to the one of either the male or female disconnectable coupling and when so connected to electrically communicate with the nondestructive inspection sensor, the electronics module being configured to move within the tubing along with the nondestructive sensor, while receiving data from the sensor without any tethering extending outside the interior of the tubing.

2. The nondestructive inspection probe system of claim 1 wherein the electronics module includes a memory for storing data from the nondestructive inspection sensor.

3. The nondestructive inspection probe system of claim 2 wherein the data is communicated from the electronics module memory to a data collection center at the end of the inspection of the tubing.

4. The nondestructive inspection probe system of claim 1 wherein the electronics module includes a control for adjusting the speed of movement of the nondestructive inspection sensor within the tubing.

5. The nondestructive inspection probe system of claim 4 wherein the control for adjusting the speed controls a drag of the nondestructive inspection sensor on the interior of the tubing.

6. The nondestructive inspection probe system of claim 1 wherein the electronics module includes a data communication protocol for communicating the data from the nondestructive inspection sensor to a remote data collection center.

7. The nondestructive inspection probe system of claim 6 wherein the data communications protocol is a wireless data transmission method.

8. The nondestructive inspection probe of claim 6 wherein the data is communicated intermittently.

9. The nondestructive inspection probe system of claim 1 including a drive system for moving the nondestructive inspection sensor through the tubing.

10. The nondestructive inspection probe system of claim 9 wherein the tubing has a first and second end and wherein the drive system creates a pressure differential between the first and second end.

11. The nondestructive inspection probe system of claim 10 wherein the drive system injects compressed gas into the tubing.

12. The nondestructive inspection probe system of claim 9 wherein the drive system comprises wheels that are driven by an electric drive motor.

13. The nondestructive inspection probe system of claim 12 wherein the wheels and the electric drive motor are on the electronics module.

14. The nondestructive inspection probe system of claim 1 wherein the electronics module includes an electric source that powers the nondestructive inspection sensor.

15. The nondestructive inspection probe system of claim 14 wherein the electronics module provides an excitation signal to the nondestructive inspection sensor and controls an excitation signal frequency and timing of the excitation signal.

16. The nondestructive inspection probe system of claim 15 wherein the electronics module provides a reference signal equivalent to a response of the nondestructive inspection sensor in clean tubing.

17. The nondestructive inspection probe system of claim 15 wherein the electronics module measure the impedance of the nondestructive inspection sensor to the excitation signal.

18. The nondestructive inspection probe system of claim 1 wherein the electronics module correlates the data to the nondestructive inspection sensor's position relative to the interior of the tubing.

19. The nondestructive inspection probe system of claim 1 wherein the electronics module communicates with a remote data center a position of the nondestructive inspection sensor and provides a fault notification.

20. The nondestructive inspection probe system of claim 1 wherein the tubing has a unique identifier and the electronics module has a monitor that reads the unique identifier and stores the unique identifier with the data.

21. The nondestructive inspection probe system of claim 20 wherein the unique identifier is a radio frequency identification tag (RFID tag) and the electronics module has a monitor that reads the RFID tag.

22. A method of inspecting tubing having a first and second end with an inspection probe connected to an electronics module, with both the inspection probe and the electronics module sized to moveably fit within the tubing without any tethering extending outside the tubing comprising the steps of:
employing a first robot to introduce the inspection probe connected to the electronics module into the first end of the tubing;
blowing or sucking the inspection probe connected to the electronics module through the tubing from the first end to the second end of the tubing;
inspecting the tubing as the inspection probe is moved through the tubing; and
employing a second robot to remove the probe connected to the electronics module from the second end of the tubing.

23. The method of inspecting tubing of claim 22 wherein the tubing comprises a first tube and a second tube supported in parallel in a tube bundle, comprising the step of sequentially employing the first robot to introduce the inspection probe into the first tube and a second inspection probe into the second tube and simultaneously blowing or sucking the inspection probe through the first tube and the second inspection probe through the second tube so that the second robot can sequentially remove the inspection probe from the first tube and the second inspection probe from the second tube.

24. The method of inspecting tubing of claim 22 wherein the tubing comprises a first and a second tube supported in parallel in a tube bundle including the steps of:
using the second robot to introduce the inspection probe connected to the electronics module into a second end of the second tube;
blowing or sucking the inspection probe connected to the electronics module through the second tube from the second end to a first end of the second tube; and
employing the first robot to remove the inspection probe connected to the electronics module from the first end of the second tube.
